(19) United States
(12) Patent Application Publication
(10) Pub. No.: US 2004/0184562 A1
(43) Pub. Date: Sep. 23, 2004

(54) METHOD AND RELATED APPARATUS FOR REDUCING IMAGE CROSS TALK IN A LOW-IF RECEIVER

(76) Inventors: Chorng-Kuang Wang, Taipei City (TW); Chien-Chih Lin, Chang-Hua Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,822

(22) Filed: Jan. 14, 2004

(30) Foreign Application Priority Data
Jan. 20, 2003 (TW) 092101076

(51) Int. Cl. H04L 1/00

(52) U.S. Cl. 375/322; 375/346

(57) ABSTRACT

The invention uses a method to minimize cross talk by minimizing the amplitude mismatch and phase mismatch between quadrature signals. The two quadrature signals are an in-phase signal and a quadrature-phase signal. The method reduces a phase mismatch between signals by compensating the quadrature-phase signal with part of the in-phase signal so that the phase difference between the signals is 90 degrees. The method also involves adjusting amplitudes of the in-phase signal and the quadrature-phase signal to the same value so as to eliminate the amplitude mismatch in the pair of quadrature signals.

### BACKGROUND OF INVENTION

1. Field of the Invention

The invention relates to a method for analyzing and reducing image cross talk, and more particularly, to a method for reducing amplitude mismatch and phase mismatch in a pair of quadrature signals to reduce image cross talk in a low-IF receiver.

2. Description of the Prior Art

In order to achieve high integration and multi-mode, there are two main architectures of a RF receiver in a wireless communications system of the prior art. One being low-IF receivers; the other being direct conversion or more commonly referred to as zero-IF receivers. Both streams are widely used and valued in industry for different reasons. The former offers the advantage of avoiding DC offset and low frequency noise but at the expense of interference by image signals. The latter reverses the situation. It does not suffer from image-signal cross talk but is affected by DC offset and low frequency noise.

Nowadays, low-IF architectures are widely applied in transmitting and receiving terminals of wireless communications systems; therefore, solving image cross talk in low-IF receivers has become an important issue in industry and academia today. The most common method in low-IF or very low-IF receivers now is utilizing a mixer to down-convert the RF signals received from the antenna and output a pair of quadrature signals which are then processed through a complex filter architecture. This low-IF receiver architecture can appropriately integrate an analog process with digital operation. For example, a publication of H. Tsurumi et al. titled “Broadband and flexible receiver architecture for software defined radio terminal using direct conversion and low-IF principle” published in the IEICE Transaction of Communication, Vol. E83-B, No. 6, pp. 1246-1253, discloses utilizing an analog process to receive and transfer signals between systems of different standards, and utilizing a digital operation to select channel of a specific system. Such an analog system-selection/digital channel-selection (ASS/DCS)method has been widely used in the industry.

In this low-IF or very low-IF receiver architecture with integration of analog process and digital operation, the utilization of a complex filter architecture for implementing a channel-selection and image rejection function is an important concept; the utilization of a complex operation architecture for processing signals is to accurately control the phase of signals. As an RF signal is received from the antenna, the low-IF receiver 10 as shown in FIG. 1 of the prior art first selects a frequency band by passing the signal through a channel selection filter 12. Next the low-noise amplifier (LNA) 14 matches the channel selection filter 12, provides signal gain with low noise factor, and sends the processed RF signal to a pair of mixers 16. The pair of mixers 16 then down-converts the processed RF signal to a predetermined frequency; and, one mixer outputs a quadrature signal known as in-phase signal I, the other mixer outputs a quadrature signal known as quadrature signal Q. Afterwards, a complex filter 18 executes image rejection in both of the quadrature signals. Finally, an analog-to-digital converter (ADC) 20 transforms the pair of quadrature signals into digital signals and transmits them to a next-end digital signal processor 22 for further processing.

There are documents and patents disclosing the complex filter 18 together with its complex signal processing architecture. For example, in “A CMOS gm-C Polyphase Filter with High Image Band Rejection,” Pietro Andreani et al. express a GM-C circuit synthesis method used in LC-ladder complex filter of a polyphase filter. Similarly, Svante Signell et al. express the concept of “Implementation of an efficient Lattice Digital Ladder Filter for up/down conversion in an OFDM-WLAN system” and disclose a new filter model, a lattice digital ladder filter (LDLF), based on the concept of a polyphase filter for implementing image rejection and down-converting by digital control. In addition Chun-Chyuan Chen and Chia-Chi Huang express that transmitting a pair of down-converted quadrature signals into two ADC respectively for transforming into digital signals and the utilization of a new phase calibration mechanism for reducing mismatch of analog components digitally to implement the functions of image rejection and down-conversion in IEEE J. Select. Areas Commun., Vol. 19, pp. 1029-1040, 2001. U.S. Pat. No. 6,373,422, “Method and apparatus employing decimation filter for down conversion in a receiver,” Mostafa et al., and U.S. Pat. No. 6,366,622, “Apparatus and method for wireless communications,” Brown et al. also describe the transmission of a received pair of quadrature signals into an ADC for transforming into digital signals and the subsequent implementation of the digital image-rejection and down-conversion functions.

Some patents focus on implementing image rejection by digitally calibrating mismatches in a pair of quadrature signals. For example, in U.S. Pat. No. 6,330,290, “Digital I/Q imbalance compensation,” Glas et al. express the utilization of a test signal and a compensation mechanism to respectively compensate the phase and amplitude of a pair of quadrature signals in a digital process. The calibration method respectively multiplies the pair of quadrature signals by a predetermined complex value for fine-tuning of phases and amplitudes of signals to the same value to achieve the objective of image rejection. However, under the architecture of the above-mentioned prior art, not only is most of the mechanism of image rejection still based on complex analysis and algorithms, but also the calibration of mismatches in quadrature signals is rather difficult to implement by only utilizing the few easily integrated components of a receiver system. And additional complex operation mechanism and components for implementing image rejection easily result in other problems such as the consumption of too much energy.

### SUMMARY OF INVENTION

It is therefore an objective of the present invention to provide a method applied in a low-IF receiver with a complex filter to solve the above-mentioned problems associated with reducing amplitude mismatch and phase mismatch in a pair of quadrature signals.

According to one embodiment of the present invention, the low IF receiver includes a programmable amplitude calibration device and a programmable phase calibration device for respectively reducing amplitude mismatch and phase mismatch in a pair of quadrature signals to reduce image cross talk.

Another objective of the present invention is to provide a method for reducing amplitude mismatch and phase mismatch between quadrature signals, wherein the quadrature signals includes an in-phase signal and a quadrature-phase signal and the method includes the steps of:

1) Reducing phase mismatch between the quadrature signals by compensating the quadrature-phase signal with a portion of the in-phase signal so that the phase difference between the compensated quadrature-phase signal and the in-phase signal becomes 90 degrees; and

2) Adjusting the amplitudes of the in-phase signal and the quadrature-phase signal to the same value so as to reduce the amplitude mismatch between the signals.

Still another objective of the present invention is to provide a method for use in a low-IF receiver to reduce image cross talk. According to one embodiment the low-IF receiver includes two mixers each of which for receiving an identical copy of the RF signal and then outputs a quadrature signal, a programmable amplitude-calibration device is electrically connected to each mixers output port to reduce amplitude mismatch a source of image cross talk between quadrature signals, and a programmable phase-calibration device electrically connected to each of the mixers for reducing phase mismatch another source of image cross talk between quadrature signals.

The method involves the use of each mixer to process its own copy of the RF signal and then output a quadrature signal. The method also involves the use of the programmable phase-calibration device to reduce phase mismatch between the output quadrature signals, wherein two ports of the programmable phase calibration device are respectively connected to the output port of the two mixers. Finally, the method involves the use of the programmable amplitude-calibration devices to reduce amplitude mismatch between the output quadrature signals.

A further objective of the claimed invention is to provide a method used in a low-IF receiver to reduce image cross talk. According to the embodiment the low-IF receiver includes two mixers, wherein each mixer receives a copy of the RF signal and then outputs a quadrature signal one being an in-phase signal and the other being a quadrature-phase signal; two programmable amplitude-calibration devices respectively electrically connected to the two mixers for reducing amplitude mismatch in the output quadrature signals; and at least one programmable phase-calibration device, wherein two ports of the programmable phase-calibration device are respectively connected to the output ports of each mixer to reduce phase mismatch between the output quadrature signals.

According to the embodiment the method includes utilizing each mixer to process its own copy of the RF signal and then output a quadrature signal; utilizing the programmable phase-calibration device to compensate the quadrature-phase signal with a portion of the in-phase signal so that the phase difference between the compensated quadrature-phase signal and the in-phase signal becomes 90 degrees thereby reducing the phase mismatch between the quadrature signals, and utilizing the two programmable amplitude calibration devices to respectively adjust amplitudes between the quadrature signals to the same value in order to reduce amplitude mismatch.

Another objective of the present invention is to provide a low-IF receiver including two mixers, each receiving a copy of the RF signal and then outputting a quadrature signal such as an in-phase signal and a quadrature-phase signal, at least one programmable amplitude-calibration device electrically connected to each mixer to reduce amplitude mismatch between the output quadrature signals, and at least one programmable phase calibration device, wherein two ports of the programmable phase-calibration device respectively connected to two output ports of the pair of mixers for reducing phase mismatch between the output quadrature signals. Each mixer is used to process a copy of the RF signal and output a quadrature signal, the programmable phase-calibration device is utilized to compensate the quadrature-phase signal with a portion of the in-phase signal so that the phase difference between the compensated quadrature-phase signal and the in-phase signal becomes 90 degrees, thereby reducing the phase mismatch between the quadrature signals; and the programmable amplitude-calibration device is utilized to adjust amplitudes of the quadrature signals to the same value so as to reduce the amplitude mismatch between the quadrature signals.

These and other objectives of the present invention will no doubt become obvious to those of ordinary skill in the art after reading the following detailed description of the embodiment that is illustrated in the various figures and drawings.

### BRIEF DESCRIPTION OF DRAWINGS

FIG. 1 is a schematic diagram of a low IF receiver according to the prior art.

FIG. 2 is a schematic diagram a low IF receiver according to one embodiment of the present invention.

FIG. 3 and FIG. 4 are schematic diagrams of phase mismatch analysis of the embodiment.

FIG. 5 and FIG. 6 are schematic diagrams of phase mismatch calibration of the embodiment.

FIG. 7 and FIG. 8 are schematic diagrams of amplitude mismatch analysis of the embodiment.

FIG. 9 and FIG. 10 are schematic diagrams of amplitude mismatch calibration of the embodiment.

FIG. 11 is a schematic diagram of simultaneously analyzing amplitude mismatch and phase mismatch in the embodiment.

FIG. 12 is a simulation diagram of image cross-talk levels in relation to different combinations of phase mismatch and amplitude mismatch values.

FIG. 13 is a schematic diagram of utilizing a portion of the components in FIG. 2 to implement a calibration mechanism.

### DETAILED DESCRIPTION

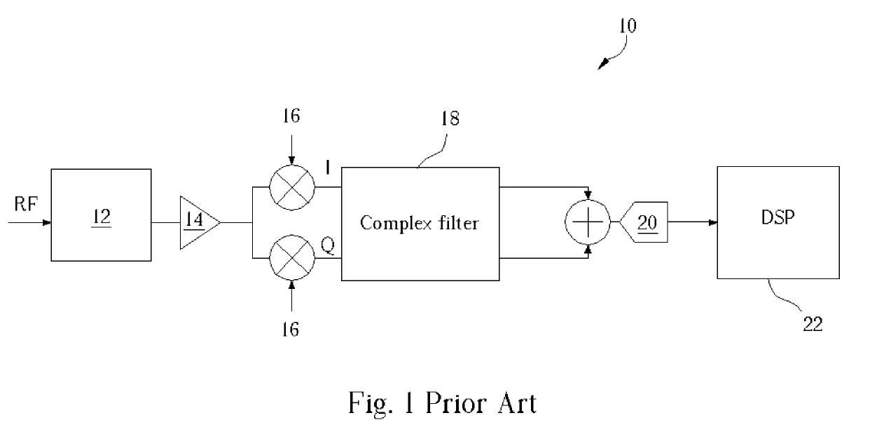

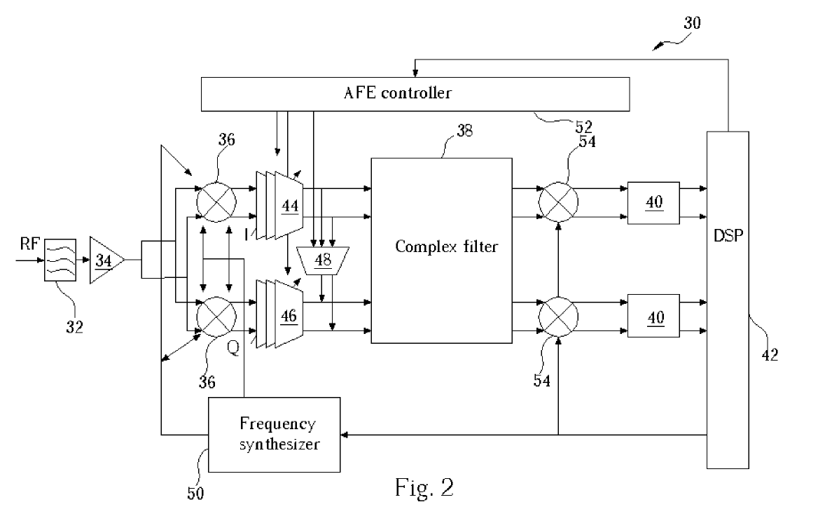

FIG. 2 illustrates a schematic diagram of a low-IF receiver 30 according to one embodiment of the present invention. The low-IF receiver 30 includes a channel selection filter 32, an LNA (low noise amplifier) 34, a pair of mixers 36, two programmable amplitude calibration devices 44 and 46 (the first programmable amplitude-calibration device 44 and the second programmable amplitude-calibration device 46), a programmable phase-calibration device 48, a complex filter 38, and two ADCs (analog-to-digital converters) 40. Compared to FIG. 1 of the prior art, FIG. 2 is physically similar in that it has a channel selection filter 32, an LNA 34, a pair of mixers 36, a complex filter 38, two ADCs 40. Each of the mixers 36 is used for processing a copy of the received RF signal. One mixer outputs an in-phase quadrature signal I, and the other outputs a quadrature signal Q. The low-IF receiver 30 of the embodiment further includes a frequency synthesizer 50 that provides each of the mixers 36 a predetermined negative frequency for use in processing the RF signal. And the complex filter 38 is next utilized for processing the quadrature signals I and Q. One difference between the embodiment and the prior art is that the low-IF receiver 30 utilizes two programmable amplitude-calibration devices 44, 46 and a programmable phase-calibration device 48 to further process the in-phase signal I and the quadrature signal Q before they are sent to the complex filter 38.

The operation of the embodiment in FIG. 2 is as follows. First, an RF signal is received from the antenna and is processed by the channel selection filter 32 for selection of a frequency band. The LNA 34 matches the channel selection filter 32, provides signal gain with low noise factor, and sends a copy of the processed signal to each of the mixers 36. Then each of the mixers 36 also referred to as an RF mixer utilizes the negative frequency provided by the frequency synthesizer 50 to down-convert the frequency of the RF signal to a predetermined lower frequency band. One mixer 36 then outputs the in-phase signal I and the other mixer 36 outputs the quadrature signal Q. Each signal is then sent to its corresponding programmable amplitude-calibration devices the in-phase signal I is sent to device 44 and the quadrature signal Q is sent to device 46 where the devices 44, 46 eliminate the amplitude mismatch in the signals. Each signal is then sent to the programmable phase-calibration device 48 via a connection between the output port of programmable amplitude-calibration devices 44, 46 and the port in the programmable phase-calibration device 48. The programmable phase-calibration device 48 then eliminates phase mismatch in the quadrature signals I and Q. The processed quadrature signals I and Q then pass through the complex filter 38 and subjected to image rejection and channel-selection. Afterwards each signal is first sent to its corresponding low-IF mixer 54 where additional processing occurs and then to its corresponding ADC 40 where it is transformed into a digital signal before finally being transmitted to a DSP 42 for further processing. In addition, the low IF receiver 30 of FIG. 2 further includes an analog front-end controller (AFE controller) 52 electrically connected to the two programmable amplitude calibration devices 44, 46 and the programmable phase calibration device 48. The AFE controller 52 is used for controlling the two programmable amplitude calibration devices 44, 46 and the programmable phase calibration device 48 in order to accurately reduce amplitude mismatch and phase mismatch in the signals I and Q.

The above embodiment of the low-IF receiver 30 can be applied in a GSM communications system or a WLAN communications system. In practical implementation, each of the programmable amplitude-calibration devices 44, 46 is a programmable gain amplifier (PGA), and the programmable phase-calibration device 48 is a cross programmable-gain amplifier (XPGA). The number of programmable amplitude-calibration devices is not necessarily limited to two as shown in the embodiment of FIG. 2. Other numbers of programmable amplitude-calibration devices used to eliminate amplitude mismatch should also be included within the spirit of the invention. Similarly, the number of the programmable phase-calibration devices 48 is not necessarily limited to one. However, since the phase-calibration device 48 is designed to eliminate phase mismatch by using both signals, any additional phase-calibration devices 48 added to the embodiment should have both the in-phase signal I and quadrature signal Q coupled to it. Additionally, the order of the programmable amplitude-calibration device 44, 46 and the programmable phase-calibration device 48 is not fixed. The quadrature signals can first be processed by the programmable amplitude-calibration device 44, 46 and then processed by the programmable phase-calibration device 48, or first processed by the programmable phase-calibration device 48 and then processed by the programmable amplitude-calibration device 44, 46. In fact, the following elaboration shows phase mismatch causes more severe image cross talk than amplitude mismatch.

As mentioned above, one feature of the embodiment is utilizing programmable amplitude-calibration devices and programmable phase-calibration devices to reduce the amplitude mismatch and the phase mismatch between the quadrature signals I and Q. To understand how to analyze and reduce the amplitude mismatch and the phase mismatch in quadrature signals according to the embodiment, a new method of image cross-talk analysis and a new method of image crosstalk calibration are discussed. The hardware architecture of programmable amplitude-calibration devices and programmable phase-calibration devices of the embodiment may also help to illustrate the feature.

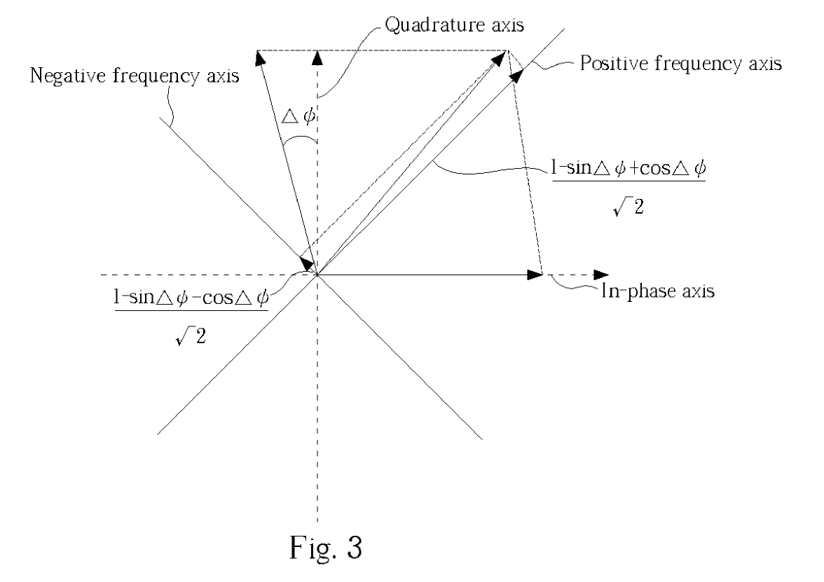

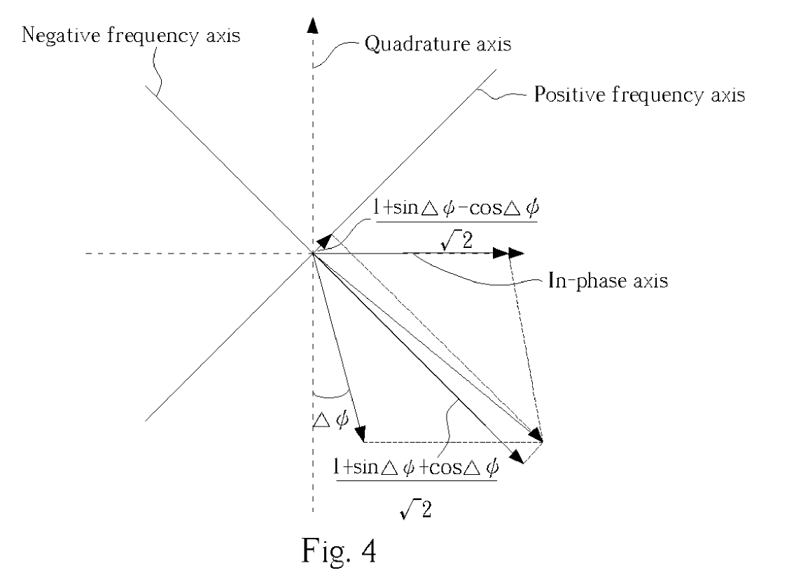

FIG. 3 and FIG. 4 illustrate schematic diagrams of phase mismatch according to the image cross-talk analysis of the embodiment. In the new method of image cross-talk analysis of the embodiment, the ideal situation occurs when:

1) The in-phase signal I lies on the in-phase axis and the quadrature signal Q lies exactly on quadrature axis.

2) The amplitudes of the two signals are the same.

3) The phase difference between the two signals equals 90 degrees.

In this situation the combination of the positive component of the in-phase signal I on the in-phase axis and the positive component of the quadrature signal Q on quadrature axis lies exactly on the positive frequency axis, and the combination of the negative component of the in-phase signal I on in-phase axis and the negative component of the quadrature signal Q on quadrature axis lies exactly on positive frequency axis. Also, the combination of the positive component of the in-phase signal I on in-phase axis and the negative component of the quadrature signal Q on quadrature axis lies exactly on negative frequency axis, and the combination of the negative component of the in-phase signal I on in-phase axis and the positive component of the quadrature signal Q on quadrature axis lies exactly on negative frequency axis. In this arrangement the components of the positive frequency and the negative frequency do not cross talk.

A phase mismatch occurs when the phase difference between the signals is not equal to 90 degrees, thus causing image cross talk. The complex filter 38 of FIG. 2 eliminates the image cross talk caused by phase mismatch by only passing the positive-frequency components and filtering all negative-frequency components. This works well in the case shown in FIG. 3 where it is assumed the in-phase signal I lies on in-phase axis but the quadrature signal Q lies at some angle Δφ left to the positive side of the quadrature axis. Since the in-phase axis and quadrature axis are 90 degrees apart, the phase difference is not equal to 90 degrees there is a phase mismatch. Therefore, the combination of the two signals of FIG. 3 does not lie exactly on the positive frequency axis. Instead, there will be a small component of the combination lying on the negative frequency axis, and causing negative cross talk. As shown in FIG. 3, assuming the value of the in-phase signal I and the quadrature signal Q are both equal to one, the quantity of cross talk on the negative frequency axis is ((1−sin Δφ−cos Δφ)√/2). This portion of signal will be eliminated due to filtration of negative frequency components by the complex filter 38, but the effect on signal quality in FIG. 3 is minor because Δφ is intrinsically small.

Referring to FIG. 4. FIG. 4 also assumes the in-phase signal I lies on in-phase axis. Meanwhile, the quadrature signal Q lies at some angle Δφ right to the negative side of the quadrature axis. This being the case, the combination of the two signals does not lie exactly on the negative frequency axis. Instead, there will be with a small component of the combination lying on the positive frequency axis, and causing positive frequency cross talk. As shown in FIG. 4, assuming the value of the in-phase signal I and the quadrature signal Q are both equal to one, the quantity of cross talk on the positive frequency axis is ((1+sin Δφ−cos Δφ)/√2). Comparing with the case of FIG. 3, the effect on signal quality in FIG. 4 is not minor but severe because the complex filter 38 only filters negative frequency components. The component of cross talk on positive frequency axis is in positive correlation with the angle Δφ. In other words, the more serious the phase mismatch between the in-phase I and quadrature signal Q is, the more serious the image cross talk is.

In order to calibrate the phase mismatch between the in-phase signal I and quadrature signal Q as shown in FIG. 4, the embodiment utilizes a new method that compensates the quadrature-phase signal by using a portion of the in-phase signal so that the phase difference between the compensated quadrature-phase signal and the in-phase signal becomes 90 degrees. Referring to FIG. 2. The programmable phase-calibration device 48 (which could be an XPGA in practical implementation) is used for compensating the quadrature signal Q with a portion of the in-phase signal I.

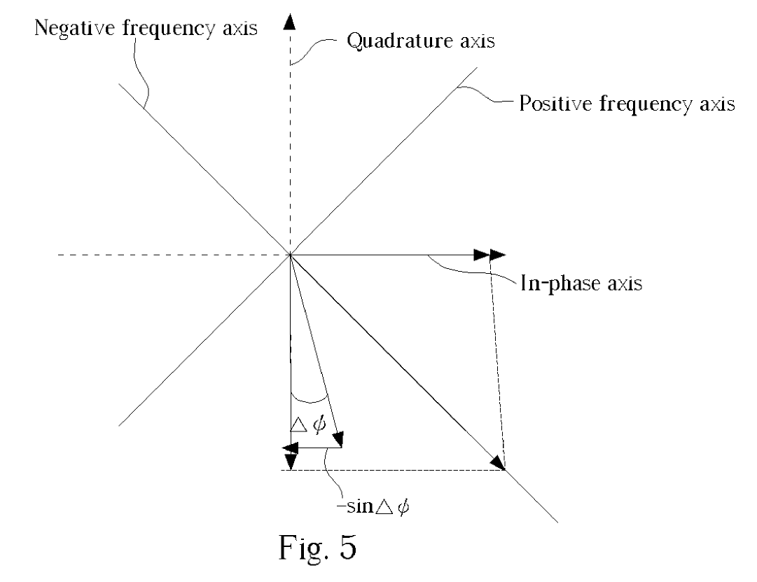

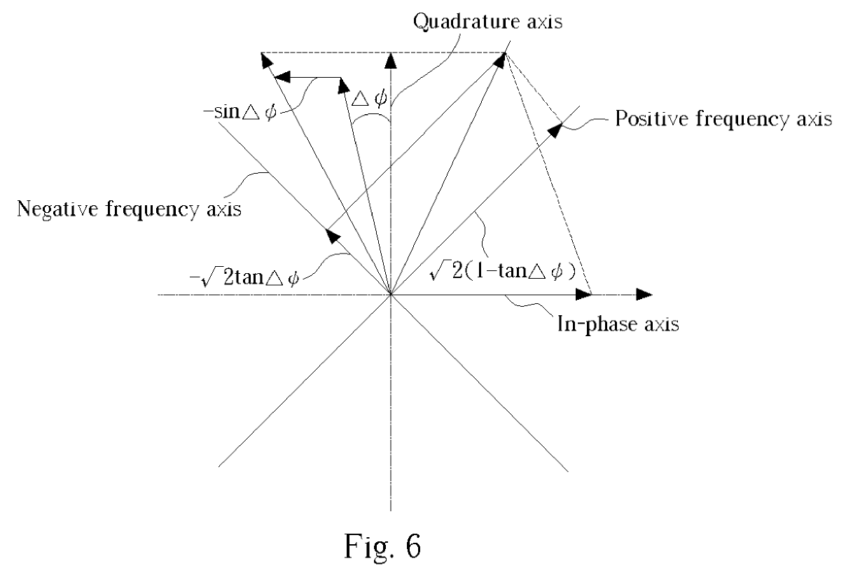

Now referring to FIG. 5 and FIG. 6 schematic diagrams of the method for calibrating image cross talk according to the embodiment. The situation in FIG. 5 is the same as the one in FIG. 3 and FIG. 4. In order to make phase difference between the pair of quadrature signals become 90 degrees, the quadrature signal Q is compensated with a portion of the in-phase signal I. As shown in FIG. 5, if the quadrature signal Q lies at some angle right to the negative side of the quadrature axis, a portion of the in-phase signal I with the value of (sin Δφ) is subtracted from the in-phase signal I, and is used to compensate the quadrature signal Q. The result is the compensated quadrature signal Q lies exactly on the quadrature axis. Hence, the combination of the positive component of the in-phase signal I on the in-phase axis and the negative component of the quadrature signal Q on the quadrature axis will lie exactly on the negative frequency axis. This means that the combination does not have a component with respect to the positive frequency axis. Without such a component, image crosstalk would not occur.

However, reducing image crosstalk is achieved at the cost of sacrificing some of the positive frequency signal. As shown in FIG. 6, the quadrature signal Q slants at an inclined angle φ from quadrature axis. After compensating the quadrature signal Q with a portion of the in-phase signal I of the value (sin Δφ), the quantity of the positive frequency signal is reduced from the ideal value of 2 to the value of (√2(1−tan Δφ). This is the cost of calibrating the phase mismatch between the in-phase signal I and the quadrature signal Q with the new method in this embodiment. If the angle Δφ is not very large, the value of tan Δφ is small and the reduction of positive frequency signal is small. Only when the phase mismatch between the in-phase signal I and the quadrature signal Q is quite large, the reduction in the positive frequency signal would be significant. That means unless the angle Δφ is very large, the reduction in positive frequency signal is tolerable.

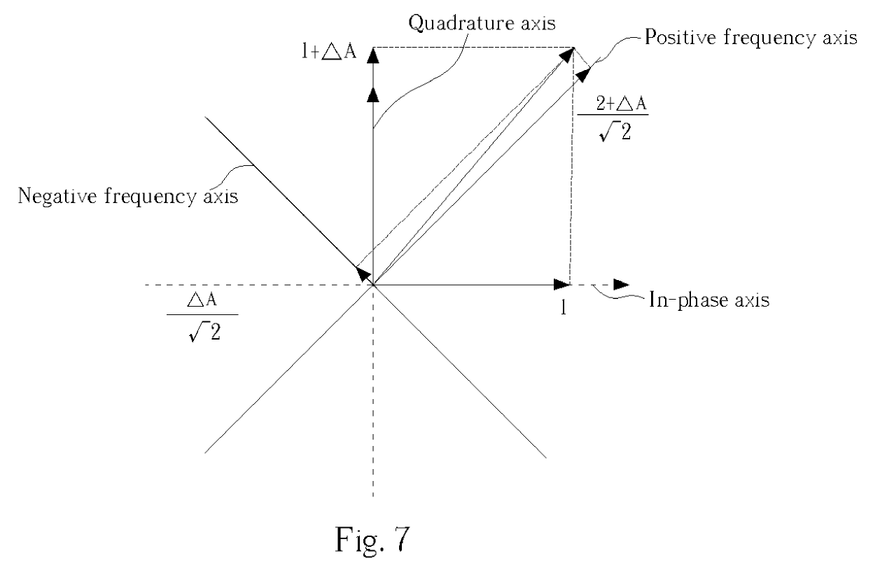

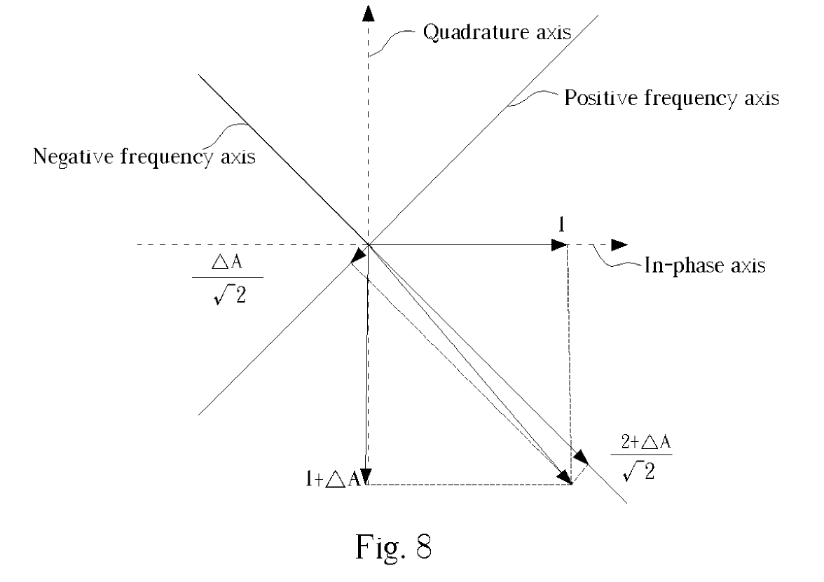

FIG. 7 and FIG. 8 are schematic diagrams illustrating the method of analyzing amplitude mismatch between two quadrature signals during image cross-talk analysis according to the embodiment. The ideal situation that this method strives for is the same as those of phase-mismatch calibration. For quick reference, the ideal situation is stated as follows:

1) The in-phase signal I lies on the in-phase axis and the quadrature signal Q lies exactly on quadrature axis.

2) The amplitudes of the two signals are the same.

3) The phase difference between the two signals equals 90 degrees.

In this situation the combination of the positive component of the in-phase signal I on the in-phase axis and the positive component of the quadrature signal Q on the quadrature axis lies exactly on the positive frequency axis, and the combination of the negative component of the in-phase signal I on the in-phase axis and the negative component of the quadrature signal Q on the quadrature axis lies exactly on the positive frequency axis. Also, the combination of the positive component of the in-phase signal I on the in-phase axis and the negative component of the quadrature signal Q on the quadrature axis lies exactly on the negative frequency axis and the combination of the negative component of the in-phase signal I on the in-phase axis and the positive component of the quadrature signal Q on the quadrature axis lies exactly on the negative frequency axis. With all the combinations lying exactly on either the positive frequency axis or the negative frequency axis, there will be no cross talk. Please note that the complex filter 38 in FIG. 2 processes cross talk by filtering all negative components.

It was previously explained that cross talk can be caused when there is a phase mismatch between the in-phase signal I and the quadrature signal Q. Cross talk can also be caused by an amplitude mismatch between the in-phase signal I and the quadrature signal Q; an amplitude mismatch is defined as a situation where the amplitudes of the in-phase signal I and the quadrature signal Q are not equal. One situation is examined in FIG. 7 where it assumes the in-phase signal I lies on the in-phase axis and has a value of one, and the quadrature signal Q lies on the quadrature axis but does not have a value equal to one. When considering the positive direction of quadrature axis, the amplitude difference between the quadrature signal Q and the in-phase signal I is ΔA. As shown in FIG. 7, the amplitude of quadrature signal Q is (1+ΔA). The amplitude mismatch in the two signals causes the combination not to lie exactly on the positive frequency axis, meaning that the combination has a small component along the negative frequency axis and causes cross talk. As shown in FIG. 7, the quantity of signal cross talk on the negative frequency axis is (ΔA/√2). The quantity of this component along the negative frequency axis has little effect on signal quality because the complex filter 38 filters all negative frequency components.

The other situation is examined in FIG. 8 where the negative direction of quadrature axis is considered. The amplitude of the quadrature signal Q is still (1+ΔA). This time the combination of the two signals does not lie exactly on the negative frequency axis. This means that a small component of the combination lies on the positive frequency axis and causes cross talk as shown in FIG. 8. The value of the component on the positive frequency axis of cross talk is (ΔA/√2), which is the same as the component on the negative frequency axis of small talk mentioned above. However, because this component of cross talk lies on the positive frequency axis in FIG. 8 and the complex filter 38 only filters components lying on the negative frequency axis, this component is passed on to the signal where it affects the signal quality rather severely. The seriousness of cross talk caused by the component lying on the positive frequency axis correlates positively with the amplitude mismatch ΔA, meaning that as the amplitude mismatch in the in-phase signal I and the quadrature signal Q increases, so does the value of ΔA, which in turn results in increased image cross talk.

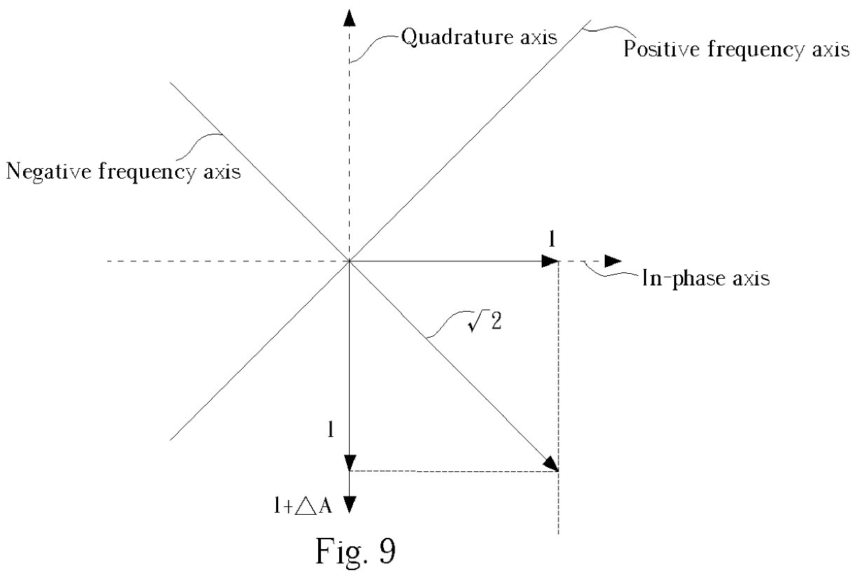

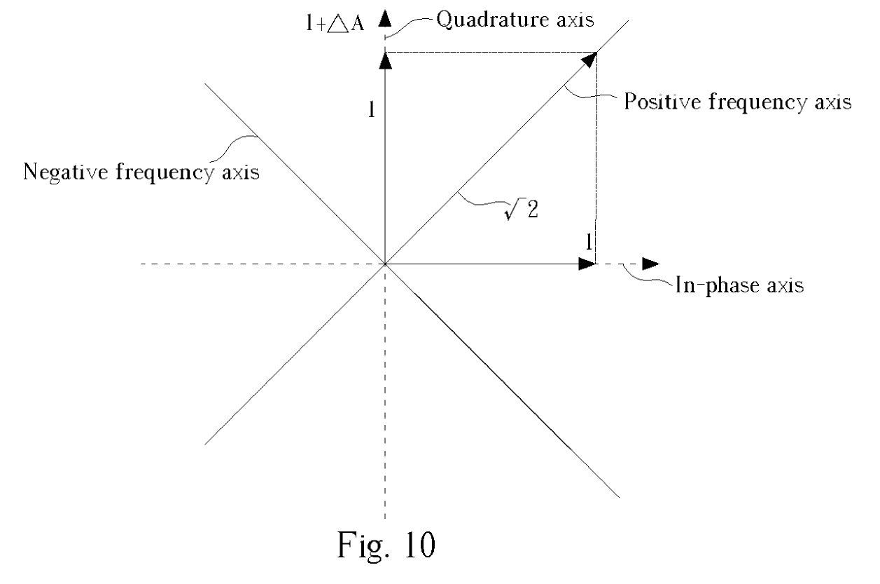

FIG. 9 and FIG. 10 illustrate schematic diagrams of image crosstalk calibration in the embodiment. In order to calibrate the amplitude mismatch between the quadrature signals in FIG. 8, the programmable amplitude calibration device 44 or 46 (which could be a PGA in practical implementation) of FIG. 2 is used to adjust the amplitudes of the in-phase signal I and the quadrature signal Q to the same values. As mentioned above, the number of the programmable amplitude calibration devices 44 and 46 is not limited to one per signal as the embodiment shown in FIG. 2. The method shown in FIG. 9 for adjusting the amplitude of the quadrature signal Q is the same as that of the in-phase signal I. The embodiment could utilize the programmable amplitude-calibration device 46 connected to the quadrature signal Q to reduce amplitude mismatch by amplifying or shrinking the quadrature signal Q. Of course, the embodiment could also utilize the programmable amplitude-calibration device 44 connected to the in-phase signal I and adjust the amplitude of the in-phase signal I to the same as that of the quadrature signal Q. The embodiment could also utilize a programmable amplitude-calibration devices 44 connected to the signal I and a programmable amplitude-calibration devices 46 connected the signal Q, or it can even use more programmable amplitude-calibration devices to accurately adjust the amplitudes in quadrature signals I and Q to the same values.

When the signals are adjusted to the same amplitudes, the combination of the positive component of the in-phase signal I on the in-phase axis and the negative component of the quadrature signal Q on the quadrature axis lies exactly on negative frequency axis. This means that the combination has no component of cross talk along the positive frequency axis. Calibrating the cross talk along the positive frequency axis has the effect of calibrating the cross talk of the negative frequency at the same time. As shown in FIG. 10, the amplitude of the quadrature signal Q along the positive quadrature axis shrinks to the same value as that of the in-phase signal I just like how the amplitude of the quadrature signal Q along the negative quadrature axis shrinks to the same as that of the in-phase signal I in FIG. 9. This represents how the method of image cross-talk calibration in the embodiment can reduce components of cross talk on the negative frequency axis and components of cross talk on the positive frequency axis at the same time.

The above description discloses the analysis of phase mismatch and amplitude mismatch respectively. However, generally the received signal suffers from both problems. So a practical implementation would be preferred if it is capable of overcoming both the phase mismatch and the amplitude mismatch problems. The following description elaborates on the situation where the component of image cross talk along the positive frequency axis is caused by both the phase mismatch and amplitude mismatch problems.

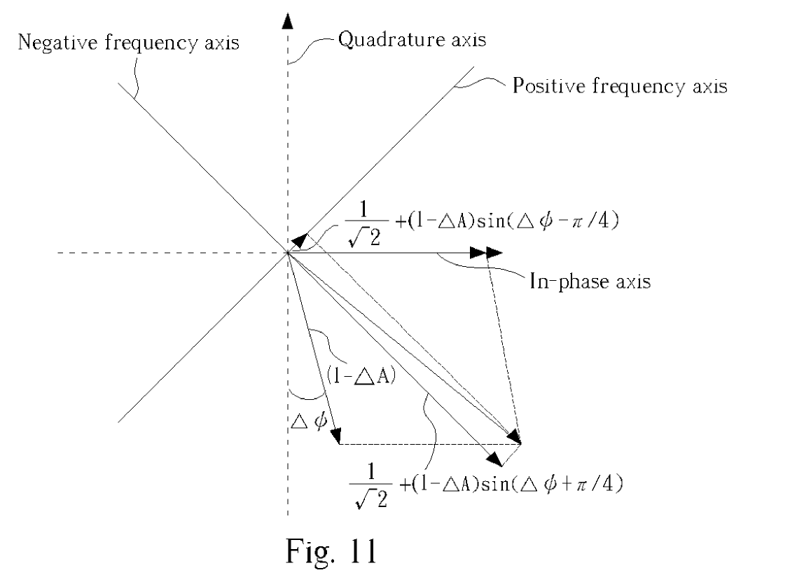

FIG. 11 illustrates a schematic diagram of the phase mismatch and the amplitude mismatch in the image crosstalk analysis. The in-phase signal I lies on the in-phase axis. The quadrature signal Q does not lie on the quadrature axis, instead, the quadrature signal Q slants at some angle Δφ right to the negative side of the quadrature axis. Additionally, the value of the in-phase signal I is one, and the amplitude mismatch between the in-phase signal I and the quadrature signal Q is ΔA. So the amplitude of the quadrature signal Q is (1−ΔA). Because of the phase mismatch and amplitude mismatch between the two signals, the combination of the two signals does not lie exactly on negative frequency axis. The value of the component of cross talk along the positive frequency axis is (1/√2+(1−ΔA)(sin(Δφ−π/4))).

As mentioned above, the component of cross talk along the positive frequency axis has a greater effect on signal quality since the complex filter 38 only filters negative frequency components. Also, the component of cross talk along the positive frequency axis correlates positively with both the angle Δφ and the amplitude mismatch ΔA. If the phase mismatch and amplitude mismatch between the quadrature signals are not reduced, the resulting image cross talk will seriously affect the signal quality and the system performance. Therefore, the method of image cross-talk calibration in the embodiment is an appropriate solution for reducing phase mismatch and amplitude mismatch.

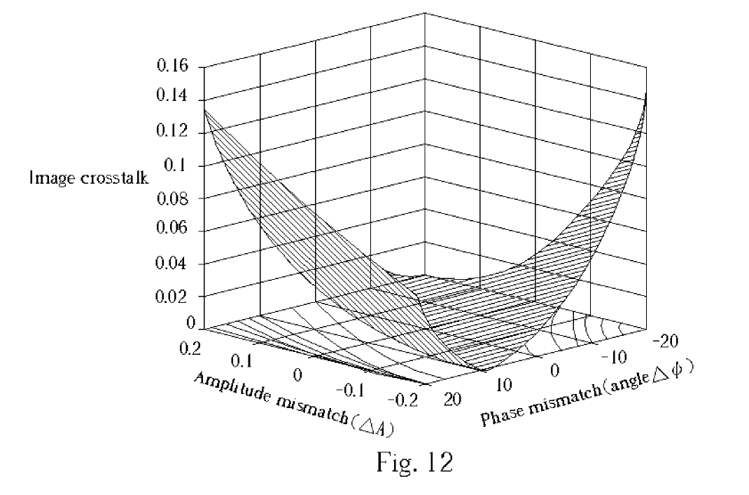

FIG. 12 illustrates a simulation diagram of image cross-talk levels vs. phase mismatch and amplitude mismatch. The value Δφ denotes the phase mismatch. The value ΔA is the ratio of the actual mismatch value to the ideal value, and denotes the amplitude mismatch. In an ideal situation where there are no phase mismatch and no amplitude mismatch, the cross talk level is zero. The analysis in FIG. 12 shows that the level of image cross talk is affected more severely by phase mismatch than that by amplitude mismatch. Therefore, a programmable phase-calibration device 48 of FIG. 2 can be used to adjust the angle Δφ between signals to find the minimum image cross-talk level. Then one of the two programmable amplitude-calibration devices 44 or 46 can be used to adjust the amplitude mismatch ΔA between the same two signals to find a new minimum image cross-talk level. This calibration mechanism can also utilize a default signal to simulate a real situation before the actual input of the signals, and the process of calibrating amplitude mismatch and then calibrating phase mismatch can be looped to repeatedly adjust image cross-talk levels until the lowest value is found.

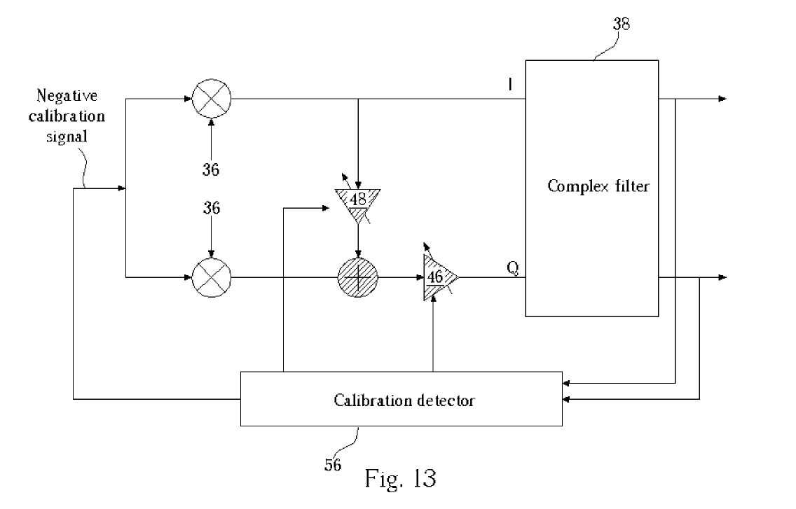

FIG. 13 illustrates a schematic diagram of above-mentioned calibration mechanism in the embodiment. For brevity, FIG. 13 only shows a portion of FIG. 2: two mixers 36, the second programmable amplitude-calibration devices 46 connected to the quadrature signal Q, a programmable phase calibration device 48, and a complex filter 38. In addition to these components, a calibration detector 56 is used to implement the above-mentioned calibration mechanism. The calibration detector 56 transmits a negative frequency-calibration signal to the two mixers 36 to simulate outputting the in-phase signal I and quadrature signal Q. The simulated, output signals are then used by the programmable phase calibration device 48 and the second programmable amplitude-calibration devices 46 to adjust the angle Δφ and the amplitude mismatch ΔA. The calibration detector 56 is connected to two output ports of the complex filter 38 to detect the processed signal repeatedly calibrated by the programmable phase calibration device 48 and the second programmable amplitude calibration device 46. In this embodiment, the calibration process is not finished until the lowest image cross-talk level is found. In this embodiment, the calibration detector 56 is a dedicated component. It is also possible to implement this function in the AFE controller 52 of FIG. 2.

The embodiment according to the present invention provides an image cross-talk analysis for analyzing the phase mismatch and the amplitude mismatch between the quadrature signals and for quantifying image cross talk. The embodiment also provides a method to reduce image cross talk by utilizing a programmable phase-calibration device to compensate for phase differences and a programmable amplitude-calibration device to calibrate amplitude mismatches in a low-IF receiver. This method avoids the use of complex analysis and algorithms to reduce the image cross talk caused by amplitude mismatch and phase mismatch between quadrature signals. Only a few components, which can be easily integrated into the system, are needed in this embodiment.

Those skilled in the art will readily observe that numerous modifications and alterations of the device may be made while retaining the teachings of the invention. Accordingly, that above disclosure should be construed as limited only by the metes and bounds of the appended claims.

1. A method for reducing amplitude mismatch and phase mismatch in quadrature signals in an RF receiver,
wherein the quadrature signals comprises a first signal and a second signal that are at about quadrature phase angles, the method comprises:
modifying the second signal by a portion of the first signal so that a phase difference between the modified second signal and the first signal becomes substantially close to 90 degrees; and
modifying amplitudes of the first signal and the second signal to substantially the same values.

2. The method of claim 1 further comprising:
compensating a portion of the first signal to the second signal to reduce phase mismatch in the pair of quadrature signals.

3. The method of claim 1 further comprising:
adjusting amplitudes of the first signal and the second signal to the same value to reduce amplitude mismatch in the pair of quadrature signals.

4. A method used in an RF receiver for reducing an image cross talk, the RF receiver comprising:
a first mixer and a second mixer for receiving RF signals and respectively generating a first signal and a second signal that are at about quadrature phase angles;
an amplitude calibration module coupled to at least one of the first mixer and the second mixer, for reducing amplitude mismatch in the pair of quadrature signals when the amplitude mismatch causes the image cross talk; and
a programmable phase calibration device coupled to the pair of mixers for reducing phase mismatch in the pair of quadrature signals when the phase mismatch causes the image cross talk;
the method comprising:
utilizing the pair of mixers to process the RF signal and to output the pair of quadrature signals;
utilizing the programmable amplitude calibration device to reduce the amplitude mismatch in the pair of quadrature signals; and
utilizing the programmable phase calibration device to reduce the phase mismatch in the pair of quadrature signals, wherein two ports of the programmable phase calibration device are respectively connected to two output ports of the pair of mixers.

5. The method of claim 4 further comprising:
utilizing the programmable phase calibration device to compensate a portion of the first signal to the second signal so that phase difference between the compensated second signal and the first signal becomes 90 degrees.

6. The method of claim 4 further comprising:
utilizing the programmable amplitude calibration device to adjust amplitudes of the first signal and the second signal to the same value.

7. A low-IF receiver comprising:
a first mixer and a second mixer for receiving RF signals and respectively generating a first signal and a second signal that are at about quadrature phase angles;
an amplitude calibration module coupled to at least one of the first mixer and the second mixer, for adjusting the amplitude of at least one of the first signal and the second signal so as to make the amplitude of the first signal and the second signal substantially equal; and
a phase calibration module coupled to at least one of the first mixer and the second mixer, for combining a portion of the first signal with the second signal so as to make the phase difference of the first signal and the second signal substantially equal to 90 degrees.

8. The low-IF receiver of claim 7 wherein the amplitude calibration module further comprises:
a first amplitude calibration device coupled to the first mixer; and
a second amplitude calibration device coupled to the second mixer.

9. The low-IF receiver of claim 7 wherein the phase calibration module further comprises a phase calibration device coupled between the first mixer and the second mixer.

10. The low-IF receiver of claim 7 further comprising an analog front end controller (AFE controller) coupled to and controlling the amplitude calibration module and the phase calibration module so as to make the amplitude of the first signal and the second signal substantially equal and make the phase difference of the first signal and the second signal substantially equal to 90 degrees.

11. The low-IF receiver of claim 7 wherein the amplitude calibration module compriese a programmable gain amplifier (PGA).

12. The low-IF receiver of claim 7 wherein the phase calibration module comprises a cross programmable gain amplifier (XPGA).

13. The low-if receiver of claim 7 being applied in a GSM communications system or a WLAN communications system.
